(19) United States
(12) Patent Application Publication
(10) Pub. No.: US 2009/0320698 A1
(43) Pub. Date: Dec. 31, 2009

(54) Multiple-emusion print screen and method for making same

(76) Inventor: Michele Katherine LaPerna Wong, Redwood City, CA (US)

Correspondence Address: Tina M. Lessani;Lessani & Lessani LLP, 163 Cypress Point Road, Half Bay Moon, CA, 94019, US

(21) Appl. No.: 12/317,302

(22) Filed: Dec. 20, 2008

Related U.S. Application Data
(60) Provisional application No. 61/133,229, filed on Jun. 26, 2008.

(51) Int. Cl. B05C 17/06

(52) U.S. Cl. 101/128.21

(57) ABSTRACT

A multiple-emulsion print screen enables designs with one or more printing materials in different patterns or heights to be created using one print screen and can also allow for printing on surfaces that are not flat. In one embodiment, the print screen comprises a mesh screen and two or more layers of emulsion. The emulsion layers have different thicknesses relative to the distance from the mesh screen. At least one of the emulsion layers resides within portions of the mesh screen and has substantially no thickness above the mesh screen. At least one other emulsion layer has a thickness over portions of the mesh screen.

### RELATED APPLICATIONS

This application claims the benefit of U.S. Provisional Application No. 61/133,229 filed on Jun. 26, 2008 and titled “Multiple-Emulsion Print Screen and Method for Making Same,” the contents of which are incorporated by reference as if fully disclosed herein.

### BACKGROUND OF THE INVENTION

1. Field of the Invention

This invention relates generally to print screens, and more specifically, to a multiple-emulsion print screen.

2. Description of the Background Art

Conventional print screens consist of a woven screen and a patterned layer of emulsion that blocks out some portion of the screen while leaving other areas open. During screen printing, ink is forced through the open areas of the screen onto an underlying substrate. For successful printing, the substrate needs to be flat and parallel to the printing screen. For example, if printing is required on substrates that have already undergone screen printing, a pattern will already be on the substrates. When printing or making a design with one or more printing materials in different patterns or heights, multiple print screens have to be used, which increases the cost and time required to make the design. In some cases, stencils of multiple thicknesses can be used instead of a print screen, but stencils cannot work for all designs. Moreover, using stencils is more expensive than using a print screen. Consequently, there is a need for a print screen that can be used to create a design with two or more print heights and allows for printing onto substrates that are not flat or may have multiple heights or patterns.

### SUMMARY

The present invention provides for a multiple-emulsion print screen and a method for making such a print screen. The multiple-emulsion print screen enables one print screen to be used for designs or objects that are comprised of one or more printing materials in different patterns or heights.

In one embodiment, the print screen comprises a mesh screen and two or more layers of emulsion. The emulsion layers have different thicknesses relative to the distance from the mesh screen. At least one of the emulsion layers resides within portions of the mesh screen and has little or no thickness above the mesh screen. At least one other emulsion layer has a thickness over portions of the mesh screen. In one embodiment, “over the mesh screen” means that the emulsion layer extends below the mesh screen when the print screen is in use.

The emulsion layers may be applied to the mesh screen using one or more patterning tools, such as a mask. The emulsion layers may or may not overlap on the mesh screen.

### BRIEF DESCRIPTION OF THE DRAWINGS

FIG. 1 illustrates a top view of an example multiple-emulsion print screen.

FIG. 2 illustrates a method, according to one embodiment, for making a multiple-emulsion print screen.

FIG. 3 illustrates a cross-sectional side view of an example multiple-emulsion print screen.

### DETAILED DESCRIPTION OF THE PREFERRED EMBODIMENTS

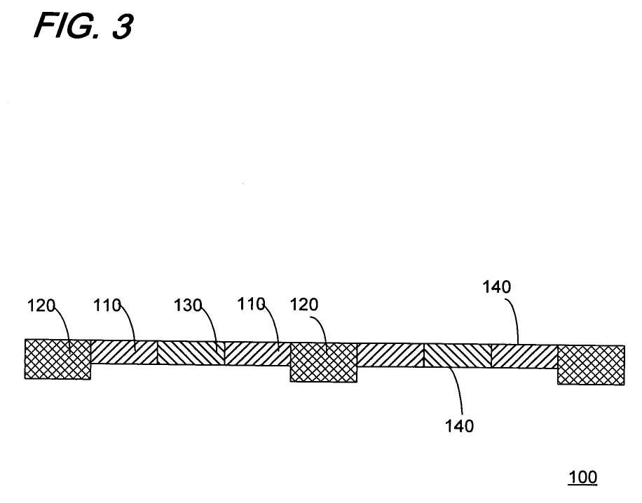

The present invention provides for a multiple-emulsion print screen and a method for making such a print screen. In one embodiment, the print screen comprises a mesh screen and two or more layers of emulsion. The emulsion layers have different thicknesses relative to the distance from the mesh screen. At least one of the emulsion layers resides within portions of the mesh screen and has a thickness substantially equal to the mesh screen, but does not substantially extend beyond the mesh screen (i.e., it has zero or close to zero thickness above the mesh screen). At least one other emulsion layer has a thickness over portions of the mesh screen. In one embodiment, “over the mesh screen” means that the emulsion layer extends below the mesh screen when the print screen is in use (see FIG. 3). This is because emulsions are typically applied to one side of the screen, but the screen is turned over for use.

The emulsion layers may be applied to the mesh screen using one or more patterning tools, such as a mask. The emulsion layers may or may not overlap on the mesh screen.

The emulsion may be any gasket material that prevents printing material (e.g., ink) from penetrating through the mesh screen. Examples of types of emulsion include Dual-Cure, Diazo, and Triazo. Examples of the type of materials that the mesh screen can be made of include stainless steel and VECREY® mesh, which is a polyairlate synthetic fiber.

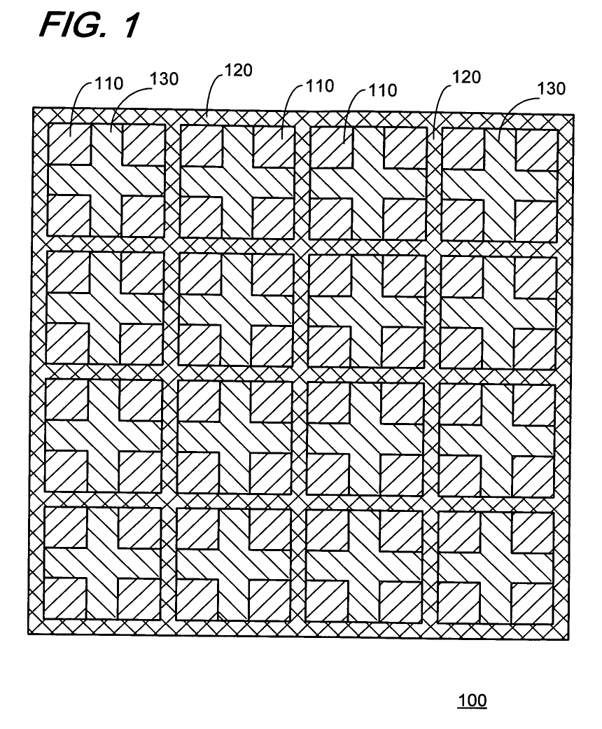

FIG. 1 illustrates a top view of an example of a multiple-emulsion print screen 100. FIG. 3 illustrates a side view of the print screen 100. In this example, the print screen includes an emulsion layer 110 that resides within the mesh screen 140. The print screen 100 also includes an emulsion layer 120 that has a thickness over portions of the mesh screen 140 (the emulsion extends below the mesh screen when the print screen is in use). Areas 130 correspond to open areas on the mesh screen 140 where printing material (e.g., ink) will penetrate the mesh screen to create a pattern of crosses.

One way in which the print screen 100 may be used is as follows: The print screen is placed over existing printing material. The existing printing material corresponds to the areas in which emulsion layer 110 resides. Areas 130 correspond to an open cavity that needs to be filled in. When the new printing material is applied to print screen 100, the new printing material fills in the open cavity 130, and the existing printing material is protected by emulsion layer 110. Emulsion layer 120 prevents the new printing material from slumping at the open edges of the cavity 130 that are not surrounded by existing printing areas 110. In other words, emulsion layer 120 provides support for open ends of cavity 130 and effectively encloses the cavity.

The print screen illustrated in FIGS. 1 and 3 have two layers of emulsion with different thickness relative to distance from the mesh screen, but the invention is not limited to a print screen with two emulsion layers. A multiple-emulsion print screen can have two or more emulsion layers, each with a different thickness relative to the distance from the mesh screen.

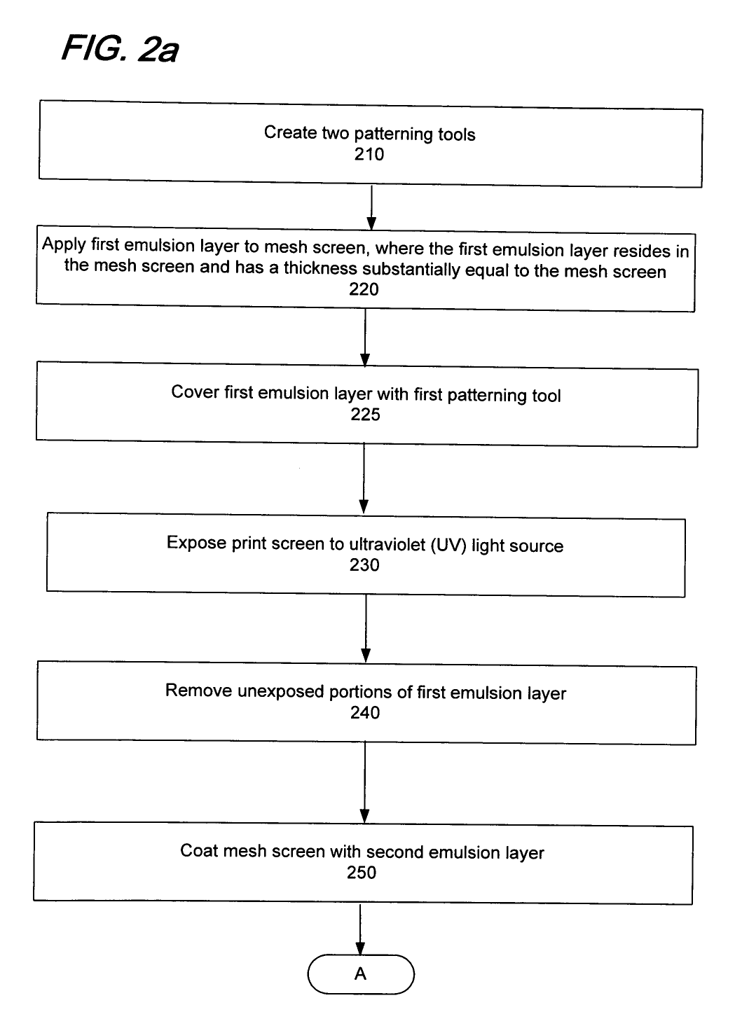

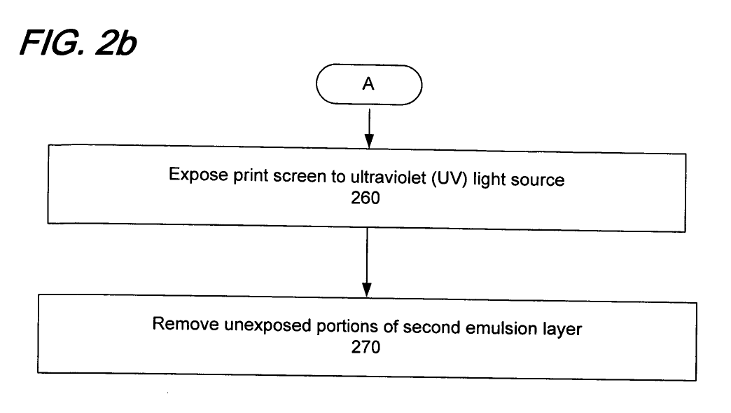

FIG. 2 illustrates a method for making a multiple-emulsion print screen with two layers of emulsion. To make the print screen, two patterning tools (one for each emulsion layer) are created (210). For example, two sets of drawing may be created and exposed to form two masks.

A first emulsion layer is applied to the mesh screen (220). The first emulsion layer resides within the mesh screen and has a thickness substantially equal to the mesh screen. The first emulsion layer is then covered with the first patterning tool (225), and the print screen is exposed an ultraviolet (UV) light source (230), where the first patterning tool protects some areas of the first emulsion layer from the UV light. The unexposed portions of the first emulsion layer are then removed (240), thereby creating a first pattern on the mesh screen of the first emulsion layer.

The mesh screen is then coated with a second emulsion layer, where the second emulsion layer has a thickness over the mesh screen (250). The second emulsion layer is then covered with the second patterning tool (255), and the print screen is exposed to a UV light source (260), where the second patterning tool protects some parts of the second emulsion layer from the UV light. The unexposed portions of the second emulsion layer are then removed (270), thereby creating a second pattern on the mesh screen with the second emulsion layer.

As will be understood by those familiar with the art, the invention may be embodied in other specific forms without departing from the spirit or essential characteristics thereof. Accordingly, the above disclosure of the present invention is intended to be illustrative and not limiting of the invention.

1. A multiple-emulsion print screen comprising:
a mesh screen;
a first emulsion layer residing within portions the mesh screen and having substantially no thickness above the mesh screen, wherein the portions of the mesh screen in which the first emulsion layer reside are determined by a first patterning tool; and
a second emulsion layer having a thickness over portions of the mesh screen, where the portions of the mesh screen on which the second emulsion layer reside are determined by a second patterning tool;
wherein the mesh screen has open areas with no emulsion layer in or on top of the mesh screen.

2. The print screen of claim 1, wherein the first emulsion layer is any gasket material that can be patterned.

3. The print screen of claim 1, wherein the second emulsion layer is any gasket material that can be patterned.

4. The print screen of claim 1, wherein the first and second emulsion layers are made of the same material.

5. The print screen of claim 1, wherein the first and second emulsion layers are made of different materials.

6. The method of claim 1, wherein the first emulsion layer and the second emulsion layer form a perimeter around the open areas.

7. The method of claim 6, wherein the second emulsion layer surrounds the open areas in places not occupied by the first emulsion later.

8. The method of claim 1, wherein the first patterning tool is a first mask.

9. The method of claim 1, wherein the second patterning tool is a second mask.

10. The multiple-emulsion print screen of claim 1, further comprising:
a third emulsion layer having a thickness over portions of the mesh screen, where the portions of the mesh screen on which the third emulsion layer reside are determined by a third patterning tool.

11. The multiple-emulsion print screen of claim 1, wherein the mesh screen is made out of metal.

12. The multiple-emulsion print screen of claim 1, wherein the mesh screen is made out of a fiber.

13. A method for creating a print screen, comprising:
preparing a first patterning tool and a second patterning tool;
applying a first emulsion layer to the mesh screen, where the first emulsion layer resides within the mesh screen and has a thickness substantially equally to the mesh screen;
covering the first emulsion layer with the first patterning tool;
exposing the mesh screen to a light source, where the first patterning tool protects portions of the first emulsion layer from exposure to the light source;
removing unexposed portions of the first emulsion layer from the mesh screen;
coating the screen with a second emulsion layer that has a thickness above the mesh screen;
covering the second emulsion layer with the second patterning tool;
exposing the mesh screen to a light source, where the second patterning tool protects portions of the second emulsion layer from exposure to the light source; and
removing unexposed portions of the second emulsion layer.

14. The method of claim 13, wherein the first emulsion layer is any gasket material that can be patterned.

15. The method of claim 13, wherein the second emulsion layer is any gasket material that can be patterned.
